(19) United States
(12) Patent Application Publication
(10) Pub. No.: US 2018/0203590 A1
(43) Pub. Date: Jul. 19, 2018

(54) ELECTRONIC DEVICE AND OPERATION METHOD OF SETTING VALUES THEREOF

(71) Applicant: ASUSTEK COMPUTER INC., Taipei (TW)

(72) Inventors: Wean-Fong LOI, Taipei (TW); Yue-Hin Victor KONG, Taipei (TW); Ee-Fun TEO, Taipei (TW)

(21) Appl. No.: 15/857,159

(22) Filed: Dec. 28, 2017

(30) Foreign Application Priority Data
Jan. 18, 2017 (TW) 106101709

(51) Int. Cl. G06F 3/0484; G06F 3/041; G06F 3/0488; G04G 21/08; G04G 9/00

(52) U.S. Cl. CPC G06F 3/04847; G06F 3/0416; G04G 9/0064; G06F 3/04883; G04G 21/08; G06F 3/0412

(57) ABSTRACT

An electronic device and an operation method of setting values are provided. The operation method includes: displaying a first value adjustment interface including a first value and an adjusting bar at a touch display; a first position of a peripheral region is touched by an object, and the touch display is switched from displaying the first value adjustment interface to displaying a second value adjustment interface. sliding from the first position to a second position along the peripheral region, according to the sliding of the object, the first value is changed to a second value corresponding to the second position; and when the object leaves the touch display switched to display the first value adjustment interface, and the first value adjustment interface includes the second value and the adjusting bar.

### CROSS-REFERENCE TO RELATED APPLICATION

This application claims the priority benefit of Taiwan application serial No. 106101709, filed on Jan. 18, 2017. The entirety of the above-mentioned patent application is hereby incorporated by reference herein and made a part of specification.

### BACKGROUND OF THE INVENTION

### Field of the Invention

The disclosure relates to an electronic device and, more particularly, to a wearable electronic device.

Description of the Related Art

More and more types of wearable electronic devices are launched. For example, a smart watch worn on the wrist usually includes many functions, such as the function of answering calls, viewing notifications, transceiving messages, playing music or monitoring a heart rate. However, since the wearable electronic device is configured to be worn on the wrist, the size of the wearable electronic device is usually not large enough, and the touch screen is usually small, which is inconvenient for the touch operation.

In addition, the setting or the operation mode of numerical values can be changed via vertical or horizontal gestures or by scrolling the numerical value on the display screen via a physical dial. However, the operation of the gestures is complicated and inconvenient for users. Moreover, most of the display screen is covered by the user's fingers in the operation, and thus it's difficult for the user to view the content.

### BRIEF SUMMARY OF THE INVENTION

According to an aspect of the disclosure, an operation method of setting values is provided. The operation method is applied to an electronic device. The electronic device includes a body and a touch display with a peripheral region. The operation method comprises the following steps: displaying a first value adjustment interface at the touch display, the first value adjustment interface includes a first value and an adjusting bar, a first end of the adjusting bar is configured at a first position of the peripheral region, and the first position corresponds to the first value; touching the first position of the peripheral region via an object, the touch display is switched from the first value adjustment interface to a second value adjustment interface, the second value adjustment interface includes the first value and the adjusting bar; sliding from the first position to a second position along the peripheral region, the first value is changed to a second value corresponding to the second position according to the sliding of the object; and switching the touch display to the first value adjustment interface when the object leaves the touch display, and the first value adjustment interface includes the second value and the adjusting bar.

According to an aspect of the disclosure, an electronic device is provided. The operation method comprises the following steps: displaying a first value adjustment interface at the touch display, the first value adjustment interface includes a first value and an adjusting bar, a first end of the adjusting bar is configured at a first position of the peripheral region, and the first position corresponds to the first value; touching the first position of the peripheral region by an object, the touch display is switched from the first value adjustment interface to a second value adjustment interface, the second value adjustment interface includes the first value and the adjusting bar; sliding from the first position to a second position along the peripheral region, the first value is changed to a second value corresponding to the second position according to the sliding of the object; and, switching the touch display to the first value adjustment interface when the object leaves the touch display, and the first value adjustment interface includes the second value and the adjusting bar.

An electronic device is further disposed, comprises a touch display, a body including a peripheral region, one or more processing units and a memory unit. The touch display includes a peripheral region. The body includes a bezel surrounding the touch display. The bezel is higher than the touch display and the peripheral region is connected to the bezel.

The processing unit is disposed in the body. The memory unit is disposed in the body and electrically connected to the processing unit. The memory unit stores one or more instructions. When one or more instructions are executed by the processing unit, the processing unit is configured to execute the following steps: displaying a first value adjustment interface at the touch display, the first value adjustment interface includes a first value and an adjusting bar, a first end of the adjusting bar is configured at a first position of the peripheral region, and the first position corresponds to the first value; touching the first position of the peripheral region by an object, the touch display is switched from the first value adjustment interface to a second value adjustment interface, the second value adjustment interface includes the first value and the adjusting bar; the object slides from the first position to a second position along the peripheral region, the first value is changed to a second value corresponding to the second position according to the sliding of the object; and switching the touch display to the first value adjustment interface when the object leaves the touch display, and the first value adjustment interface includes the second value and the adjusting bar.

In sum, according to the smart watch and the operation method of setting values in the embodiments, when the object touches the first position of the peripheral region of the touch display corresponding to the first value, the touch display is changed from the first value adjustment interface to a second value adjustment interface. Then, the object slides from the first position to the second position along the peripheral region. When the object leaves the touch display, the touch display is switched to show the first value adjustment interface including the second value corresponding to the second position. Therefore, the value can be adjusted via one sliding gesture. Since the peripheral region of the touch display is connected to the bezel, and the bezel is higher than the touch display, users can set the value conveniently and quickly. In addition, since the sliding operation is in a specific area of the display screen, the covered area of the display screen is small, it is convenient for users to watch and set the values.

### BRIEF DESCRIPTION OF THE DRAWINGS

FIG. 1A is a flow chart of an operation method of setting values on a smart watch in an embodiment;

FIG. 1B is functional block diagram of a smart watch in an embodiment;

FIG. 1C is a schematic diagram showing an appearance of a smart watch in an embodiment;

FIG. 1D is a schematic diagram showing an operation of a smart watch in an embodiment; and

FIG. 2A to FIG. 2E are schematic diagrams showing different display images of the smart watch in FIG. 1C.

### DETAILED DESCRIPTION OF THE EMBODIMENTS

An electronic device and an operation method of setting values according to an embodiment of the present invention will be described with reference to the drawings. The same number denotes the same component. The electronic device is a smart watch, a cellphone, or a laptop, which is not limited. In the following embodiments, the electronic device is a smart watch as an example.

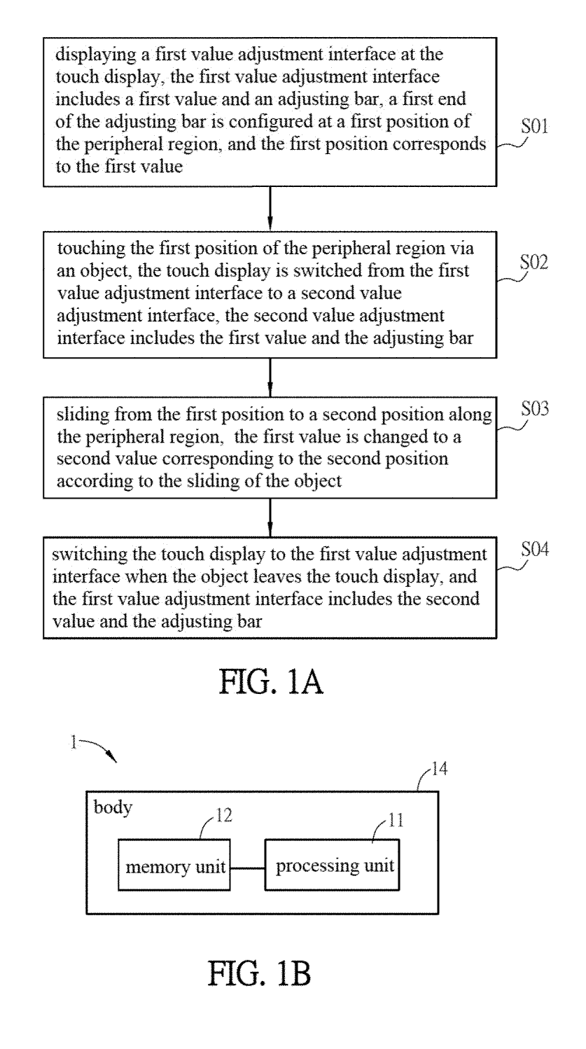

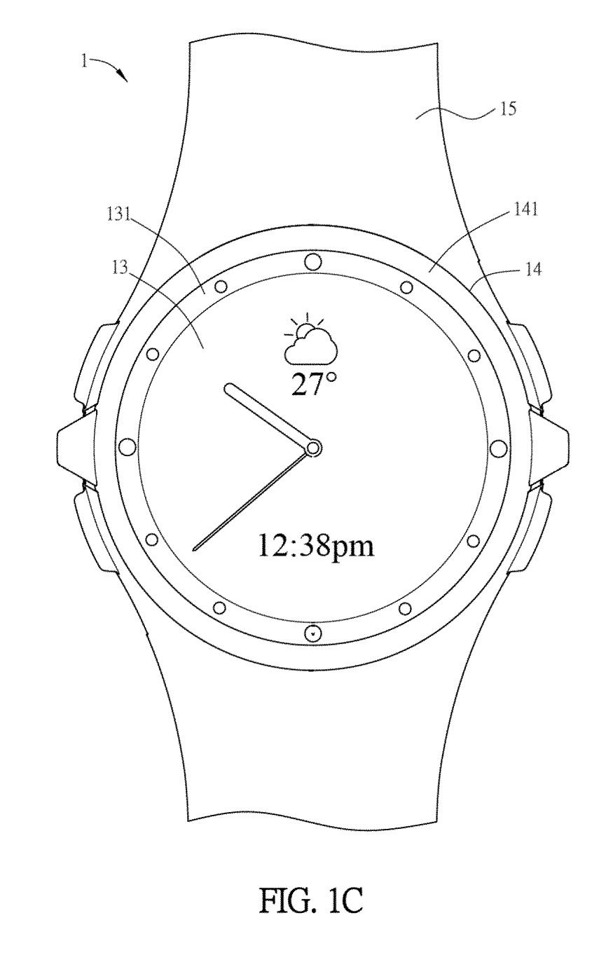

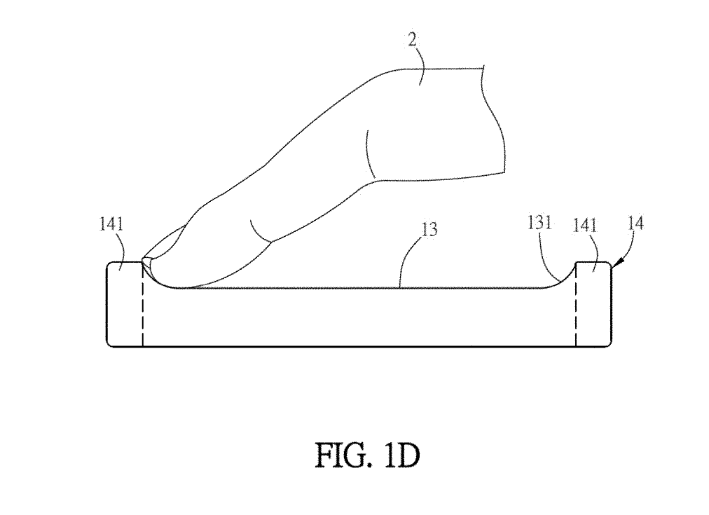

Please refer to FIG. 1A to FIG. 1D. FIG. 1A is a flow chart of an operation method of setting values on a smart watch in an embodiment. FIG. 1B is functional block diagram of a smart watch in an embodiment. FIG. 1C is a schematic diagram showing the appearance of a smart watch in an embodiment. FIG. 1D is a schematic diagram showing the operation of a smart watch in an embodiment.

When the user wants to adjust and set the value of the smart watch, such as the time adjustment, the display brightness adjustment, and other numerical adjustments, the smart watch should enter the numerical value adjustment interface (such as the time adjustment interface) for the following operation. As shown in FIG. 1A, the operation method of setting values on a smart watch includes the following steps. In step S01, a first value adjustment interface is displayed on a touch display. The first value adjustment interface includes a first value and an adjusting bar. A first end of the adjusting bar is located at a first position of the peripheral region. The first position corresponds to the first value.

In step S02, an object touches a first position of the peripheral region, and the touch display is switched from the first value adjustment interface to a second value adjustment interface. The second value adjustment interface includes the first value and an adjusting bar.

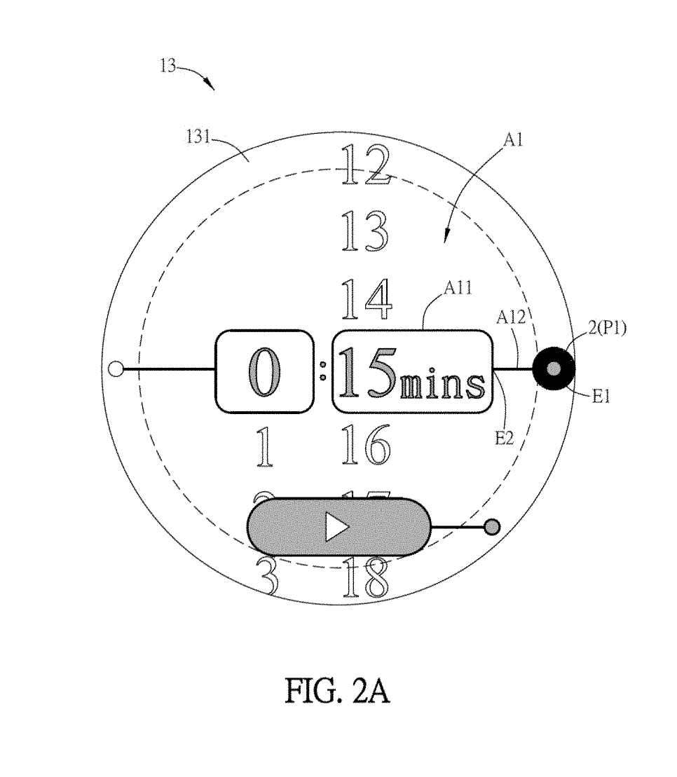

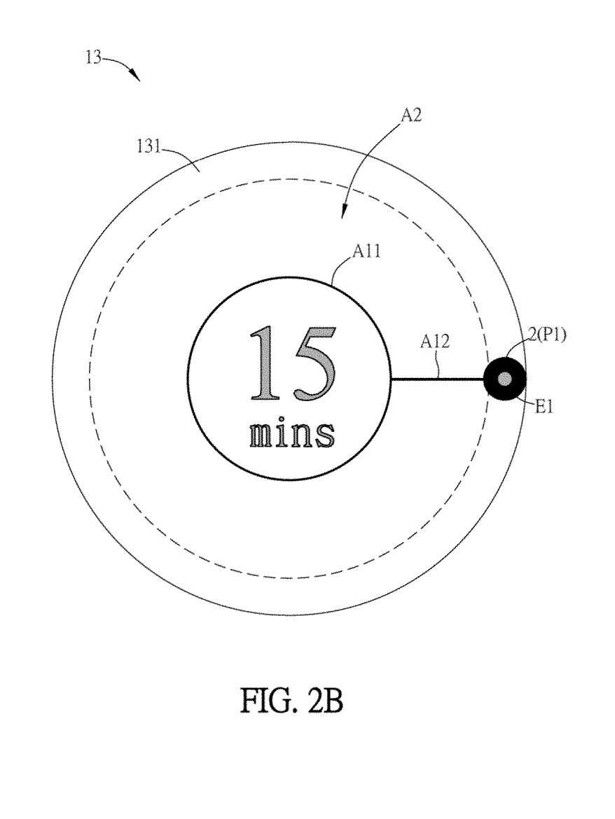

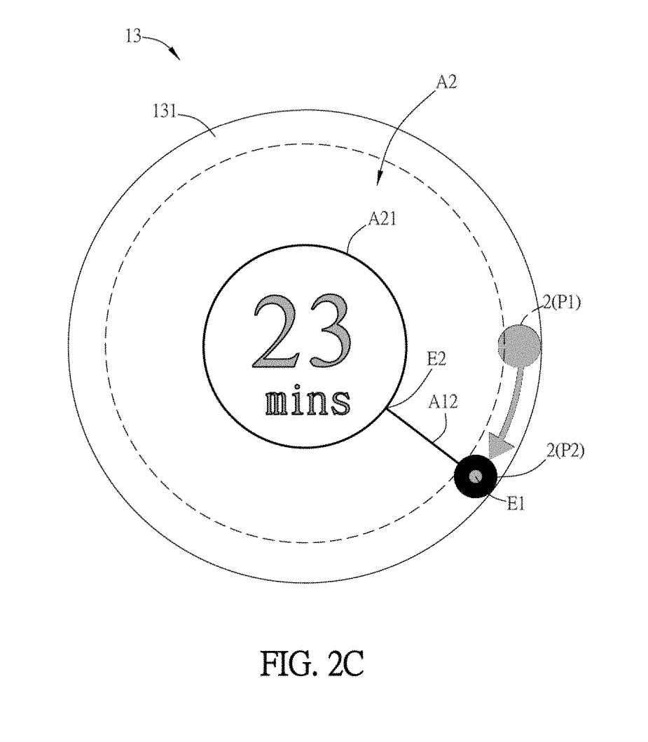

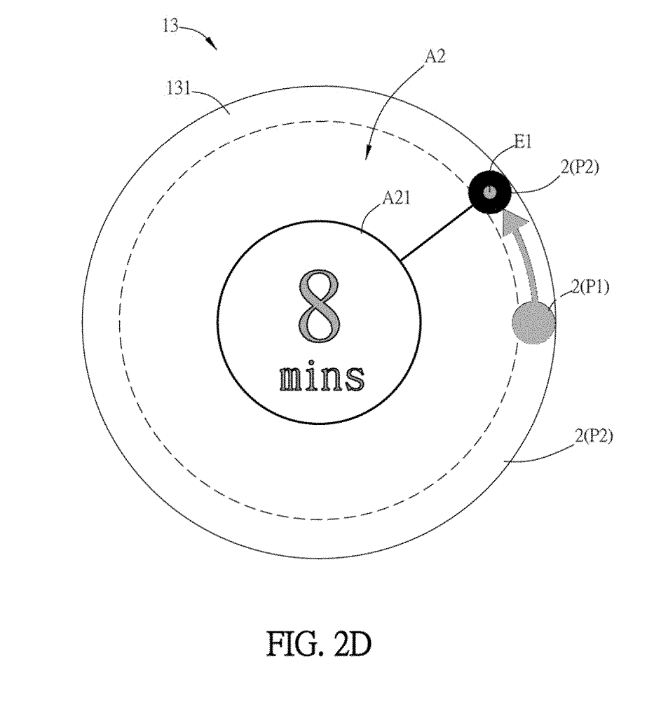

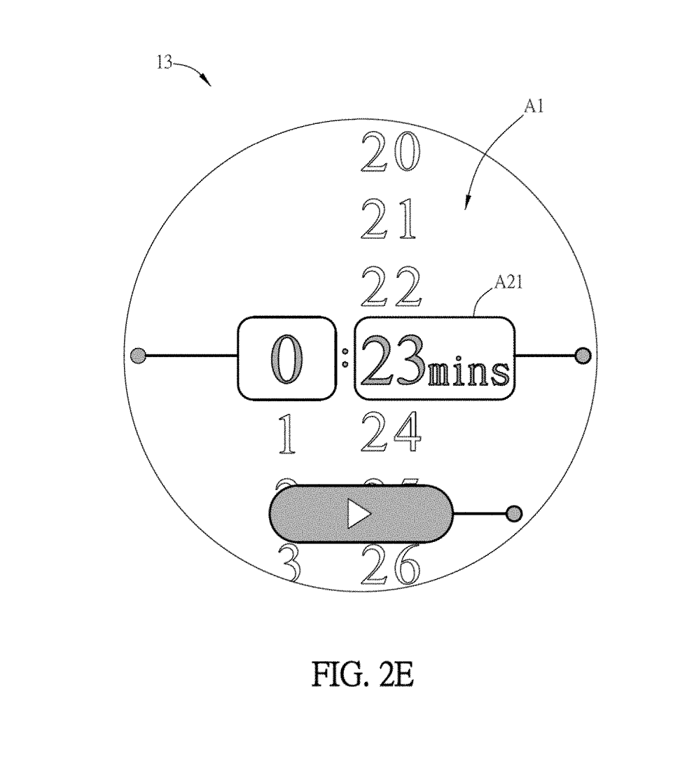

In Step S03, the object slides from the first position to a second position along the peripheral region. The first value is changed to a second value corresponding to the second position according to the sliding of the object. In step S04, when the object leaves the touch display, the touch display is switched to display the first value adjustment interface. The first value adjustment interface includes the second value and the adjusting bar. The adjustment and the setting of the smart watch is described in detail with refer to FIG. 1B to FIG. 2E hereinafter.

As shown in FIG. 1B, the smart watch 1 includes one or more processing units 11, a memory unit 12 and a body 14. The memory unit 12 is electrically connected to one or more processing units 11. The processing unit 11 and the memory unit 12 are disposed in the body 14, respectively. In an embodiment, one processing unit 11 and one memory unit 12 are disposed in the body 14.

The processing unit 11 can access the data stored in the memory unit 12. The processing unit 11 includes control components of the smart watch 1. In an embodiment, the processing unit 11 includes a central processing unit (CPU) and a memory, or other control hardware, software or firmware, which is not limited.

The memory unit 12 stores at least one application software, such as APP software including one or more instructions. When one or more program instructions are executed by the processing unit 11 to adjust the value, the steps S01 to S04 are executed via the processing unit 11, which will be described in detail below.

In an embodiment, the memory unit 12 is a non-transitory computer readable storage medium, such as a memory, a memory card, a compact disc, a video tape, a computer tape, or any combination thereof. In an embodiment, the memory is a read-only memory (ROM), a flash memory, or a Field-Programmable Gate Array (FPGA), or a combination thereof. In an embodiment, the memory unit 12 is a memory inside the smart watch 1. In an embodiment, the memory unit 12 is a cloud memory at a cloud device. The application software is stored in the cloud device. The application software is executed after the application software is loaded to the smart watch 1 from the cloud device.

In addition, please refer to FIG. 1C and FIG. 1D, the smart watch 1 further includes a touch display 13 and a watch band 15. The watch band 15 is connected to the body 14 and is worn on the wrist. The body 14 includes a bezel 141 surrounding the touch display 13. A height of the bezel 141 is higher than that of the touch display 13. In addition, the touch display 13 includes a peripheral region 131.

The peripheral region 131 is at the outer periphery of the touch display 13. The peripheral region 131 is connected to the bezel 141. As shown in FIG. 1D, the height of the peripheral region 131 is decreased gradually from the height of the bezel 141 to the height of an inner side of the touch display 13. Thus, an object 2 (such as finger) slides along the peripheral region 131 of the touch display 13 conveniently. Moreover, the object 2 is prevented from sliding out of the touch display 13 via a blocking of the bezel 141 with a higher height.

Please refer to FIG. 2A to FIG. 2E, the steps of the operation method of setting values on the smart watch are illustrated in detail. FIG. 2A to FIG. 2E are schematic diagrams showing different display images of the smart watch in FIG. 1C.

The touch display 13 of the smart watch 1 has a display and touch function. Therefore, the smart watch 1 is controlled and operated when the object 2, such as a finger or a stylus, touches the touch display 13 or slides on the touch display 13.

When the user wants to adjust a value, as shown in FIG. 2A, the processing unit 11 controls the touch display 13 to display the first value adjustment interface A1. The first value adjustment interface A1 includes at least a first value A11 and an adjusting bar A12. The first end E1 of the adjusting bar A12 is located at the first position P1 of the peripheral region 131. The second end E2 of the adjusting bar A12 is connected to the display pattern of the first value A11. The first position P1 corresponds to the first value A11 (step 01).

In an embodiment, the first value adjustment interface A1 is a time adjustment interface which includes “hour (0)” on the left and “minute (15 minutes)” on the right. For example, the first value A11 is “minute (15 minutes)”. The adjusting bar A12 is connected to “minute (15 minutes)”. The value of “minute” is adjusted via the adjusting bar A12. In embodiments, the first value A11 and the adjusting bar A12 are located at the middle, right of the touch display 13, which is not limited herein. If the user wants to adjust the “hour” on the left side, the “hour” is adjusted and set via another adjusting rod (not shown) connected to “hour”. The adjusting process is similar to the adjustment of “minute”, which is not repeated again herein.

In addition, the display pattern of the first value A11 includes numbers, letters, and border lines. Thus, the display pattern of the first value A11 includes “15 mins” and border lines at the periphery. The second end E2 of the adjusting bar A12 is connected to the border lines of the display pattern. In addition, the first position P1 corresponds to the number of the first value A11. The first position P1 also corresponds to the position of the first end E1 of the adjusting bar A12. The two positions overlap (shown as “2(P1)”).

As shown in FIG. 2A and FIG. 2B, the operation method of setting values further includes the following steps. The object 2 touches the first position P1 of the peripheral region 131(as shown FIG. 2A, the first position P1 touched by the object 2 and the object are together marked as 2(P1)). When the processing unit 11 receives that the object 2 touches the first position P1 of the peripheral region 131, the touch display 13 is switched from the first value adjustment interface A1 to the second value adjustment interface A2 (FIG. 2B).

The second value adjustment interface A2 includes the first value A11 and the adjusting bar A12 (step S02). In the embodiment, the first value A11 at the second value adjustment interface A2 is highlighted. For example, the value is highlighted by the way of increasing the brightness with a same size, changing the size of the pattern, changing colors, or anti-white, which is not limited herein. In the embodiment, the pattern is changed, and the pattern size is enlarged (the numbers are not changed).

Next, the object 2 slides from the first position P1 to the second position P2 along the peripheral region 131. When the processing unit 11 receives the gesture of the object 2 sliding from the first position P1 to the second position P2 along the peripheral region 131, the first value A11 is synchronously changed to the second value A21 corresponding to the second position P2 according to the sliding of the object 2 (step S03).

During the sliding from the first position P1 to the second position P2, the first end E1 of the adjusting bar A12 moves in synchronization with the object 2. The adjusting bar A12 also moves along with the sliding of the object 2. The second end E2 of the adjusting bar A12 is still connected to the display pattern of the second value A21. The object 2 slides in the clockwise direction or in the counterclockwise direction. The first value A11 increases when the object 2 slides in the clockwise direction. The first value A11 decreases when the object 2 slides in the counterclockwise direction, which is not limited herein.

As shown in FIG. 2C, when the user wants to adjust “minute” from 15 minutes to 23 minutes, the object 2 slides from the first position P1 to a second position P2 corresponding to 23 minutes. During the sliding of object 2, the value of “minute” is also gradually increased from 15 to 23. In an embodiment, as shown in FIG. 2D, when the object 2 slides from the first position P1 to the second position P2 in the counterclockwise direction, the first value A11 changes from 15 to 8 corresponding to the second position P2.

The sliding distance of the object 2 from the first position P1 to the second position P2 is nonlinear with the second value A21. For example, the sliding distance of the object 2 from the first position P1 to the second position P2 is 5 cm. The second value A21 is related (or not related) to the sliding distance. In an embodiment, the sliding distance of the object 2 from the first position P1 to the second position P2 is in linear with the value change from the first value A11 to the second value A21.

For example, when the sliding distance from the first position P1 to the second position P2 is ¼ turn of the peripheral region 131, the value change from the first value A11 to the second value A21 is 15 minutes. When the sliding distance from the position P1 to the second position P2 is ½ turn of the peripheral region 131, the value change from the first value A11 to the second value A21 is 30 minutes. When the sliding distance from the first position P1 to the second position P2 is a full turn of the peripheral region 131, the value change of the first value A11 to the second value A21 is 60 minutes.

That is, in the above embodiment, the sliding distance of the object 2 is proportional to the change of the numerical value. In addition, the time for adjusting the first value A11 to the second value A21 is determined according to the speed when the object 2 slides from the first position P1 to the second position P2.

That is, the faster the speed of the sliding (or the faster the velocity is) is, the shorter the time for the adjustment from the first value A11 to the second value A21 is. In the sliding operation, the object 2 slides along the peripheral region 131 inside the bezel 141. Since the height of the bezel 141 is higher than the height of the touch display 13, the object 2 would not slide out of the touch display 13, which is convenient in operation.

Then, when the object 2 leaves the second position P2 and does not touch the touch display 13, the touch display 13 is switched from the second value adjustment interface A2 to the first value adjustment interface A1. The first value adjustment interface A1 includes the second value A21 and the adjusting bar A12 (step S04). As shown in FIG. 2E, when the value of “23 minutes” is already reached, the object 2 leaves the touch display 13 and does not touch another position of the touch display 13, the processing unit 11 controls the control display surface 13 to display the first value adjustment interface A1 instead of the second value adjustment interface A2. At this time, the first value adjustment interface A1 includes the second value A21 which is adjusted according to the requirement of the user, that is, the value of 23 minute.

During the operation process, the object 2 slides along the peripheral region 131 of the touch display 13, but not move to the region inside the peripheral region 131 of the touch display 13. Thus, the covered area of the display screen is small, which is convenient for users to watch and set the values.

In sum, according to the smart watch and the operation method of setting values in the embodiments, when the object touches the first position of the peripheral region of the touch display corresponding to the first value, the touch display is changed from the first value adjustment interface to a second value adjustment interface. Then, the object slides from the first position to the second position along the peripheral region. When the object leaves the touch display, the touch display is switched to show the first value adjustment interface including the second value corresponding to the second position.

Therefore, the value can be adjusted via one sliding gesture. Since the peripheral region of the touch display is connected to the bezel, and the bezel is higher than the touch display, users can set the value conveniently and quickly. In addition, since the sliding operation is in a specific area of the display screen, the covered area of the display screen is small, it is convenient for users to watch and set the values.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. An operation method of setting values, applied to an electronic device with a body and a touch display, the touch display includes a peripheral region, and the operation method comprising:
displaying a first value adjustment interface at the touch display, the first value adjustment interface includes a first value and an adjusting bar, a first end of the adjusting bar is configured at a first position of the peripheral region, and the first position corresponds to the first value;
touching the first position of the peripheral region via an object, the touch display is switched from the first value adjustment interface to a second value adjustment interface, the second value adjustment interface includes the first value and the adjusting bar;
sliding from the first position to a second position along the peripheral region, the first value is changed to a second value corresponding to the second position according to the sliding of the object; and
switching the touch display to the first value adjustment interface when the object leaves the touch display, and the first value adjustment interface includes the second value and the adjusting bar.

2. The operation method according to claim 1, wherein the body includes a bezel surrounding the peripheral region, the bezel is higher than touch display, a height of the peripheral region is decreased to the height of the touch display from the bezel toward an inner side of the touch display.

3. The operation method according to claim 1, wherein a second end of the adjusting bar is connected to a display pattern of the first value or the display pattern the second value.

4. The operation method according to claim 1, wherein in the step of sliding from the first position to the second position, the first end of the adjusting bar moves in synchronization with the object.

5. An electronic device, comprising:
a touch display including a peripheral region;
a body;
a processing unit disposed in the body; and
a memory unit disposed in the body and electrically connected to the processing unit, the processing unit is configured to execute the following steps:
displaying a first value adjustment interface at the touch display, the first value adjustment interface includes a first value and an adjusting bar, a first end of the adjusting bar is configured at a first position of the peripheral region, and the first position corresponds to the first value;
touching the first position of the peripheral region via an object, the touch display is switched from the first value adjustment interface to a second value adjustment interface, the second value adjustment interface includes the first value and the adjusting bar;
receiving that the object slides from the first position to a second position along the peripheral region, the first value is changed to a second value corresponding to the second position according to the sliding of the object; and
switching the touch display to the first value adjustment interface when the object leaves the touch display, and the first value adjustment interface includes the second value and the adjusting bar.

6. The electronic device according to the claim 5, wherein the body includes a bezel surrounding the peripheral region, a height of the peripheral region is decreased to the height of the touch display from the bezel toward an inner side of the touch display.

7. The electronic device according to the claim 5, wherein a second end of the adjusting bar is connected to a display pattern of the first value or the display pattern of the second value.

8. The electronic device according to the claim 5, wherein when the object slides from the first position to the second position, the first end of the adjusting bar moves in synchronization with the object.

9. The electronic device according to the claim 5, wherein the object slides in a clockwise direction or a counterclockwise direction.
